(19) United States
(12) Patent Application Publication
(10) Pub. No.: US 2007/0102347 A1
(43) Pub. Date: May 10, 2007

(54) Temperature-responsive membrane, temperature-responsive membrane module, and membrane filtration system in which the same are used

(75) Inventors: Takeshi Matsushiro, Kanagawa (JP); Manabu Sakurai, Kanagawa (JP); Shuji Seki, Kanagawa (JP); Hideki Nakamura, Kanagawa (JP); Kenichi Hinoshita, Tokyo (JP); Takahiro Soma, Kanagawa (JP); Masahiko Tsutsumi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/592,962

(22) Filed: Nov. 6, 2006

(30) Foreign Application Priority Data
Nov. 8, 2005 (JP) P2005-324151

(51) Int. Cl. B01D 29/00

(52) U.S. Cl. 210/490; 210/500.38; 210/500.35; 210/500.41

(57) ABSTRACT

Provided is a membrane filtration system which makes it possible to improve operation rate of the system by increasing the amount of water to be treated, and to reduce costs required for chemical washing and replacement of a membrane. Accordingly, a total running cost is reduced. The membrane filtration system is provided with temperature-responsive membrane modules for filtering supplied raw water to discharge it as treated water. In each of the temperature-responsive membrane modules, temperature-responsive membranes are formed into any one of planar and cylindrical forms, and are then filled into a container.

### CROSS-REFERENCE TO RELATED APPLICATION

This application is based upon and claims the benefit of priority from the prior Japanese Patent Application No. 2005-324151, filed on Nov. 8, 2005. The entire contents of which are incorporated herein by reference.

### BACKGROUND OF THE INVENTION

1. Field of the Invention

The present invention relates to a temperature-responsive membrane, a temperature-responsive membrane module and a membrane filtration system using the same, which are suitable for treating water: for example, freshwater such as river water, groundwater and lake water; waste water such as stored rainwater, industrial wastewater and sewage water; and seawater such as ballast water.

2. Description of the Prior Art

In the field of water treatment, for example, a microfiltration membrane, an ultrafiltration membrane, a nanofiltration membrane, and a reverse osmosis membrane have so far been used as a method of filtering raw water (freshwater such as river water, groundwater and lake water; waste water such as stored rain water, industrial wastewater and sewage water; seawater such as ballast water) to obtain domestic water, industrial water and agricultural water.

The membranes have a high performance in separating solid contents, such as microorganisms, algae, and clay in raw water. In recent years, a hydrophilic material is generally used as a material for the membranes. In addition, it is considered that the filtration performance thereof is improved by applying a hydrophilic treatment to a surface of each membrane by using a sulfuric acid solution of potassium dichromate, even in a case where the hydrophobic material is used (refer to, for example, Japanese Patent Laid-Open Official Gazette No. Hei 5-23553).

However, when the raw water is continuously caused to flow therethrough, filtration resistance of the membrane is increased because the solid contents in the raw water accumulate on the membrane surface and in the interior of the membrane. Accordingly, as the operation time elapses, filtration performance of the membrane may be decreased due to (1) a change in quality of the membrane itself and (2) external factors. The change in quality of the membrane itself includes physical deteriorations such as compaction and damage of the membrane, chemical deteriorations caused by hydrolysis, oxidization and the like, and biological deteriorations such as assimilation of the membrane by microorganisms. The external factors include accumulation of fine particles and suspended matters on the membrane surface. In this case, membrane pressure difference is increased so as to get the necessary amount of treated water. For this reason, there is a possibility that energy required for the operation of the membrane filtration system is increased.

Accordingly, in such a membrane filtration system, a physical washing is performed thereto so as to remove reversible matters among matters adhered on the membrane surface or in the interior of the membrane. Such physical washing includes flowing the filtration-treated water from the treated water side and sending compressed air from the raw water side, at a predetermined time cycle or at a time when a predetermined increase in the membrane pressure difference is found.

On the other hand, on the membrane surface and in the interior of the membrane, the matters which cannot be removed by means of such physical washing are gradually accumulated. For this reason, when the membrane pressure difference exceeds a predetermined upper limit, the membrane filtration treatment is stopped, and chemical washing is performed thereon to remove the adhered matters which have not been removed by means of the physical washing.

In such a membrane filtration system, while repeating the physical washing, the following washing cycle is repeated to extend the service life time of the same filtration membrane as long as possible. In the washing cycle, the chemical washing is carried out when the membrane pressure difference exceeds a predetermined value. In a case where the matters adhered on the membrane surface and in the interior of the membrane cannot be removed by the chemical washing any more so that the restoration of the membrane pressure difference cannot therefore be found, or in a case where the service life time of the membrane exceeds a certain period, the membrane is judged to have reached the end of its service life time, and is replaced. In such cases, the membrane filtration treatment must be stopped each time the filtration membrane is caused to undergo the chemical washing, or is replaced. Because of this, it is necessary to reduce the frequencies of the chemical washing and replacement of the filtration membrane as much as possible. It is also necessary to increase operation rate of the membrane filtration system, as well as to reduce costs required for the chemical washing and the replacement of the membrane.

### SUMMARY OF THE INVENTION

Taking into consideration the above problems, an object of the present invention is to provide a temperature-responsive membrane, a temperature-responsive membrane module and a membrane filtration system using the same, which are suitable for treating water. In the membrane filtration system, operation rate of the system can be improved by increasing the amount of water to be treated, and costs required for the chemical washing and replacement of the membrane can be reduced. Accordingly, a total running cost can be reduced.

In order to achieve the above object, a temperature-responsive membrane according to the present invention is characterized as follows. The temperature-responsive membrane is configured of a membrane substrate and pore diameter adjustment members. The membrane substrate is made of a polymeric material and has many pores therein. Each of the pore diameter adjustment members is formed by adding a polymeric material on the outer surface side of the membrane substrate. The polymeric material reversibly expands/contracts at a predetermined temperature. The pores formed in the membrane substrate have the maximum diameter of 100 μm or less at 25 to 60° C. In addition, the polymeric material is formed of at least one selected from the group consisting of the following materials (1) to (7).

(1) polymers formed by copolymerizing N-isopropyl acrylamide with acrylic acid, 2-carboxy isopropyl acrylamide, 3-carboxy-n-propyl acrylamide,

(2) N-vinyl isobutyric acid amide polymers,

(3) poly-N-alkyl acrylamide derivatives,

(4) copolymers of polyacrylamide derivatives represented by polyisopropyl acrylamide with polyvinyl derivatives,

(5) copolymers of N-vinylC₃₋₉acylamide such as N-vinyl isobutyric acid amide with N-vinylC₁₋₃acylamide such as N-vinyl acetamide,

(6) polyacrylamide derivatives and poly-N-vinyl acylamide, and

(7) polymers of monomers consisting of N-isopropyl acrylamide and polymers of monomers consisting of N-vinyl isobutyric acid amide.

Additionally, a temperature-responsive membrane module of the present invention is characterized in that the temperature-responsive membrane described above is formed into a planar or cylindrical form, and is filled into a container.

Additionally, a temperature-responsive membrane module of the present invention is characterized in that a plurality of the temperature-responsive membranes described above are formed into a planar or cylindrical form, and immersed in a tank into which raw water flows.

Moreover, a membrane filtration system of the present invention is characterized by including one of the temperature-responsive membrane modules described above.

According to the present invention, an excellent washing effect on the membrane can be achieved, and increase of pressure difference can be restrained over a long period of time. Therefore, the cycle of the chemical washing and replacement of the membrane can be reduced. This allows the increase in the operating rate of the membrane filtration system, and the reduction in the cost which is required to chemically wash or replace the membrane, resulting in reduction in the total running cost.

### BRIEF DESCRIPTION OF THE DRAWINGS

FIGS. 1A and 1B are schematic views showing a cross-sectional configuration of a temperature-responsive membrane according to the present invention.

FIG. 2 is an explanatory view showing relationship between the ratio of expansion and contraction of pore diameter of the temperature-responsive membrane according to the present invention with the temperature of liquid.

FIG. 3 is an explanatory view showing types of temperature-responsive membrane modules.

FIG. 4 is a schematic view showing a configuration of a casing accommodation type of a cylindrical membrane module which is an example of the temperature-responsive membrane module according to the present invention.

FIGS. 5A and 5B are schematic views showing a configuration of a planar membrane module which is an example of the temperature-responsive membrane module according to the present invention.

FIG. 6 is a block diagram showing a first embodiment of the membrane filtration system according to the present invention.

FIG. 7 is a block diagram showing another example of the first embodiment of the membrane filtration system according to the present invention.

FIG. 8 is a block diagram showing a second embodiment of the membrane filtration system according to the present invention.

FIG. 9 is a block diagram showing a third embodiment of the membrane filtration system according to the present invention.

FIG. 10 is a block diagram showing a fourth embodiment of the membrane filtration system according to the present invention.

FIG. 11 is a block diagram showing a fifth embodiment of the membrane filtration system according to the present invention.

FIG. 12 is a block diagram showing a sixth embodiment of the membrane filtration system according to the present invention.

FIG. 13 is a block diagram showing a seventh embodiment of the membrane filtration system according to the present invention.

FIG. 14 is a block diagram showing an eighth embodiment of the membrane filtration system according to the present invention.

FIG. 15 is a block diagram showing a ninth embodiment of the membrane filtration system according to the present invention.

FIG. 16 is a block diagram showing a tenth embodiment of the membrane filtration system according to the present invention.

### DETAILED DESCRIPTION OF THE PREFERRED EMBODIMENTS

### Embodiment of Temperature-Responsive Membrane

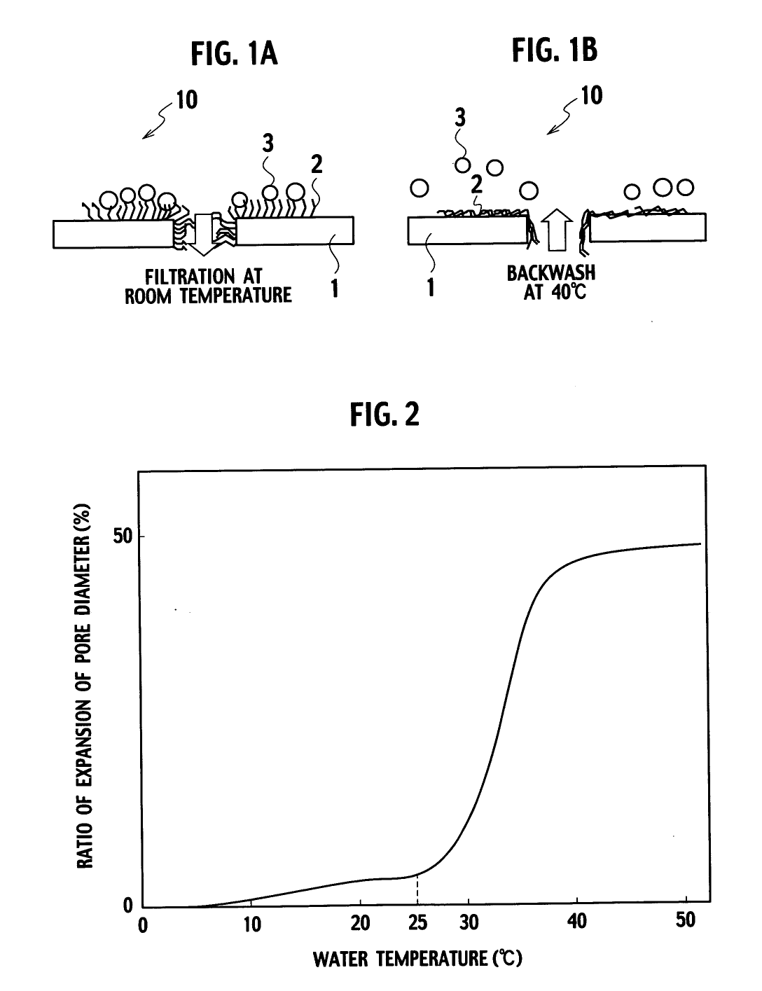

FIGS. 1A and 1B show an embodiment of a temperature-responsive membrane according to the present invention.

The temperature-responsive membrane 10 according to the present invention consists of a membrane substrate 1 and a pore diameter adjustment member 2. The membrane substrate 1 is made of a polymeric material. The pore diameter adjustment member 2 is formed by adding a polymeric material on the external surface side of the membrane substrate 1. The polymeric material reversibly expands/contracts at a given temperature. N-isopropyl acrylamide is an example of the pore diameter adjustment member 2. N-isopropyl acrylamide is not responsive to temperature by itself. However, a polymer obtained by polymerizing N-isopropyl acrylamide is responsive to temperature.

As shown in FIG. 1A, the raw water containing solid contents 3 (freshwater such as river water, groundwater and lake water; waste water such as stored rain water, industrial waste water and sewage water; sea water such as ballast water) is filtered through the temperature-responsive membranes 10 having pores with a diameter of 100 μm or less. By the screening effect of the temperature-responsive membranes 10, matters in the raw water, each of which has a larger diameter than those of the pores, are then trapped by the membrane surfaces and the pore diameter adjustment members 2. The solid contents 3 contained in the raw water include bacteria such as Escherichia coli, protozoa such as Cryptosporidium and Giardia, and plankton, in addition to inorganic materials such as silica colloids, bentonites and clays. These solid contents 3 include carboxyl groups, amino groups, hydroxyl groups, and the like.

In the present embodiment, filtration and backwash are carried out by utilizing the expansion and contraction of a polymer chain corresponding to variations of temperature. That is, by using the temperature-responsive membrane 10, the solid contents 3 are trapped on the upper surface of the membrane when the raw water flows from above the membrane to below the same.

At the time of the backwash, as shown in FIG. 1B, the polymeric material is expanded/contracted by heating the raw water stagnating above the membrane surface or backwash water supplied from below the membrane surface to a temperature ranging from 25 to 60° C. during carrying out the backwash in a direction from below the membrane surface to above the same.

As described above, N-isopropyl acrylamide is not responsive to temperature by itself. However, a polymer obtained by polymerizing N-isopropyl acrylamide is responsive to temperature.

Filtration and backwash are carried out by utilizing the expansion and contraction of the polymer chain of N-isopropyl acrylamide corresponding to such a change in temperature. Specifically, by using a temperature-responsive hollow fiber membrane of the present invention, the raw water is flowed from an outer surface side of the hollow fiber membrane to an inner surface side thereof. As a result, the solid contents in the raw water are trapped on the outer surface side. Subsequently, during carrying out the backwash from the inner surface side of the hollow fiber membrane to the outer surface side thereof, the raw water stagnating on the outer surface side of the hollow fiber membrane is heated at 25 to 60° C. As a result, the polymer chains of N-isopropyl acrylamide contracts. At this time, the diameters of the pores of the temperature-responsive membrane 10 are increased (opened) as the polymer chains contract due to dehydration.

The pore diameter adjustment member 2 made of N-isopropyl acrylamide has an amide group as the side chain. As shown in FIG. 2, the pore diameter adjustment member 2 is hydrated to expand at about 25° C. or less, and is dehydrated to contract at more than 25° C. At near 40° C., the contraction also reaches nearly a plateau. Accordingly, the backwash water is desirably heated at a range of 25 to 60° C. to contract the polymeric material.

In addition, at this time, the membrane pressure difference is generally about 5 to 30 kPa. SYOUKIBO-SUIDOU NI OKERU MAKU-ROKA-SISETSU DOUNYU GAIDORAIN (Guideline For Membrane Filtration Facility Introduction for Small-Scale Water Line) issued by Japan Water Research Center specifies that a membrane pressure difference shall be a maximum of 150 kPa in the case of a microfiltration membrane, and 300 kPa or less in the case of an ultrafiltration membrane. It is therefore desirable that the membrane pressure difference is maintained at the same as or less than those values.

As described above, in the conventional membrane, the solid contents 3 having carboxyl groups, amino groups, hydroxyl groups and the like, adhere to the membrane surface by hydrogen bonding. The solid contents 3 are thus difficult to be removed by simple backwash only. A bonding force between the solid contents 3 and the membrane surface can be weakened by heating the raw water on the side of the membrane surface on which the solid contents 3 have been trapped and the treated water at 25 to 60° C. during carrying out backwash. This makes it easier to remove the solid contents, in addition to the above effects.

As the polymeric material, considered are (1) polymers formed by copolymerizing N-isopropyl acrylamide with acrylic acid, 2-carboxy isopropyl acrylamide and 3-carboxy-N-propyl acrylamide, (2) N-vinyl isobutyric acid amide copolymers, (3) poly-N-alkyl acrylamide derivatives, (4) copolymers of polyacrylamide derivatives represented by polyisopropyl acrylamide with polyvinyl derivatives, (5) copolymers of N-vinylC₃₋₉acylamide such as N-vinyl isobutyric acid amide with N-vinylC₁₋₃acylamide such as N-vinyl acetamide, (6) polyacrylamide derivatives and poly-N-vinyl acylamide, and (7) polymers of monomers consisting of N-isopropyl acrylamide and polymers of monomers consisting of N-vinyl isobutyric acid amide. Note that, the temperature-responsive membrane is not limited to these polymers. The temperature-responsive membrane may be any polymeric material which reversibly expands/contracts at a predetermined temperature.

### Embodiment of Temperature-Responsive Membrane Module

An embodiment of the temperature-responsive membrane module according to the present invention will hereinafter be described.

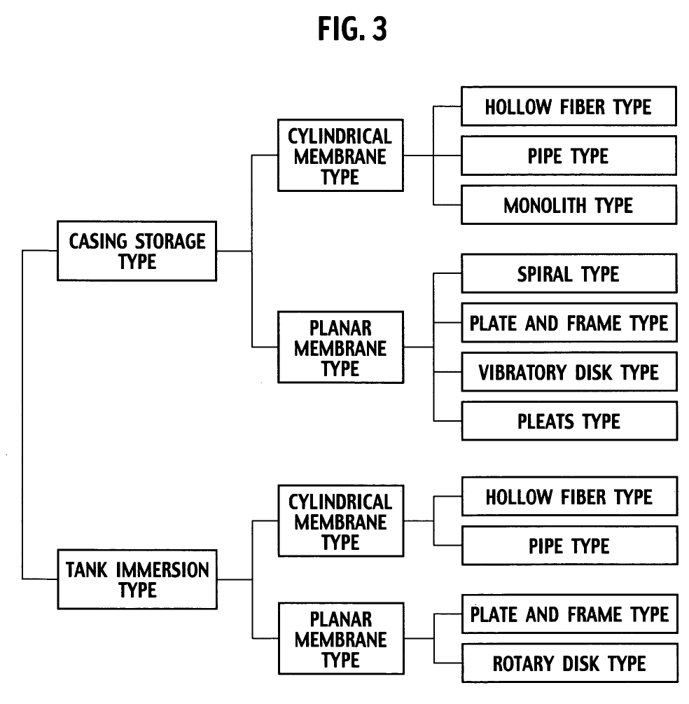

The shapes of membranes and modules may be classified as shown in FIG. 3. Note that, this classification is cited from SUIDOU-YOU MAKU-ROKA-GIJUTSU NO ATARASHII TENKAI (New Development of Membrane Filtration Technology for Water Line) issued by Japan Water Research Center.

As shown in FIG. 3, the shapes of the membrane module are roughly divided into a casing accommodation type and a tank immersion type. Moreover, the shapes of the module to be loaded in each membrane module are divided into cylindrical membranes and planar membranes. The cylindrical membranes of the casing storage type are divided into a hollow fiber type, a pipe type and a monolith type. The planar membranes of the casing accommodation type are divided into a spiral type, a plate and frame type, a vibratory disk type and a pleats type. The cylindrical membranes of the tank immersion type are divided into a hollow fiber type and a pipe type. The planar membranes of the tank immersion type are divided into a plate and frame type and a rotary disk type.

### First Embodiment of Temperature-Responsive Membrane Module

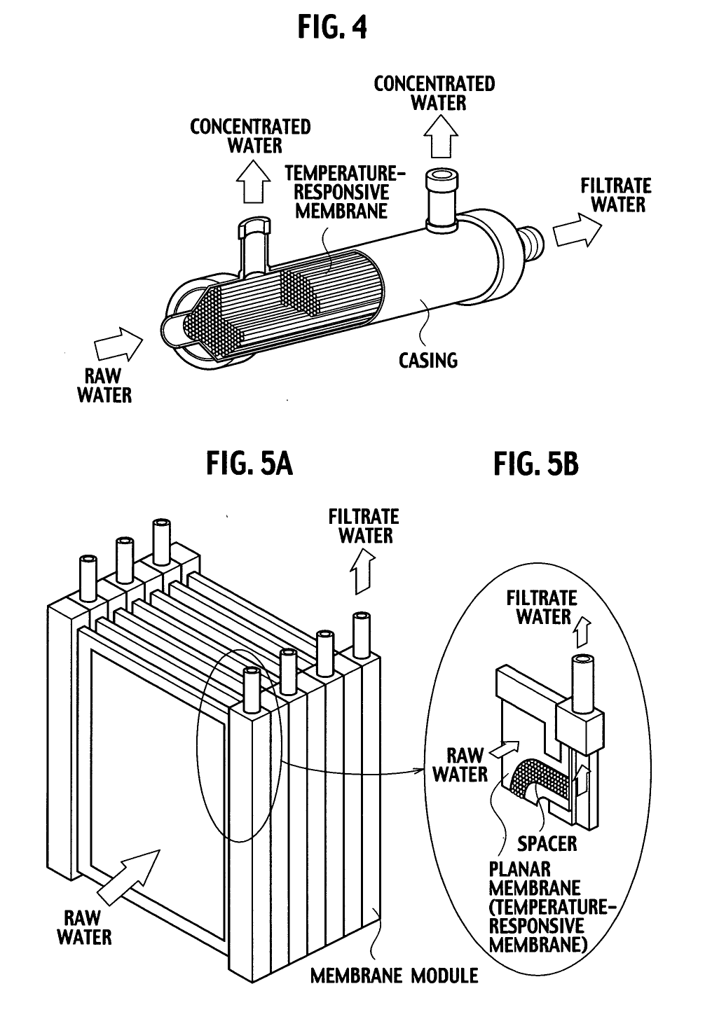

FIG. 4 shows a first embodiment of the temperature-responsive membrane module according to the present invention.

As shown in FIG. 4, a large number of temperature-responsive membranes are loaded into a cylindrical casing in the direction of a cylinder axis. The raw water is filtered during passing through the temperature-responsive membranes to be separated into membrane filtrate (treated water) and concentrated water (waste water).

In this case, the raw water containing the solid contents 3 (refer to FIGS. 1A and 1B) (freshwater such as river water, groundwater and lake water; waste water such as stored rain water, industrial waste water and sewage water; sea water such as ballast water) is filtered through the temperature-responsive membranes each having pores with a diameter of 100 μm or less. By the screening effect of the temperature-responsive membrane, matters in the raw water, each of which has a diameter larger than those of the pores, are then trapped by the membrane surfaces and the diameter adjustment members 2. In a case where the membranes are unified with a container, the raw water is flowed along the membrane surfaces. The treated water then flows in a direction perpendicular to the direction of the flow of the raw water. This makes it possible to carry out the filtration either by a cross-flow filtration method in which a part of the raw water is circulated, or by a dead end filtration method in which all the raw water is filtered without circulating the raw water.

### Second Embodiment of Temperature-Responsive Membrane Module

FIGS. 5A and 5B show a second embodiment of the temperature-responsive membrane module according to the present invention.

As shown in FIGS. 5A and 5B, the temperature-responsive membrane module of this embodiment is configured by stacking a plurality of the temperature-responsive membrane modules each formed in a planar form. When the raw water flows into the interior of the module from the planar surface thereof as shown in FIG. 5A, the raw water passes through the interiors of the membranes to become a membrane filtrate (treated water) as shown in FIG. 5B. This temperature-responsive membrane module can be used in the state of being immersed in the tank (opened type, or closed type) into which the raw water flows.

As described above, in the first and second embodiments of the temperature-responsive membrane module, the temperature-responsive membranes are formed into a cylindrical or planar form, and are filled into and unified with a container. A membrane filtration area can thus be increased. In addition, the temperature-responsive membranes are formed into a cylindrical or planar form, and immersed in the tank (opened type or closed type) into which the raw water flows. These make it possible to simplify the system, and to thus facilitate the replacement of the membranes. Accordingly, the system can be stably operated even when the raw water supplied to the membranes has a high turbidity.

In the present invention, the temperature-responsive membranes are formed in a planar or cylindrical form, and the membranes are filled into and unified with the container, but the configuration thereof is not limited to these. As examples of a unified form, there are various forms, such as the hollow fiber type, the pipe type, the monolith type, the spiral type, the plate and frame type, the vibratory disk type, and the pleats type. The unified form is, however, not limited to these forms.

Moreover, in the present invention, the temperature-responsive membranes are formed in a planar or cylindrical form. In addition, the membranes are immersed in the tank (opened type, or closed type) into which the raw water flows. As examples of the form, there are the hollow fiber type, the pipe type, the plate and frame type, and the rotary disk type. It is, however, not limited to these types.

### First Embodiment of Membrane Filtration System

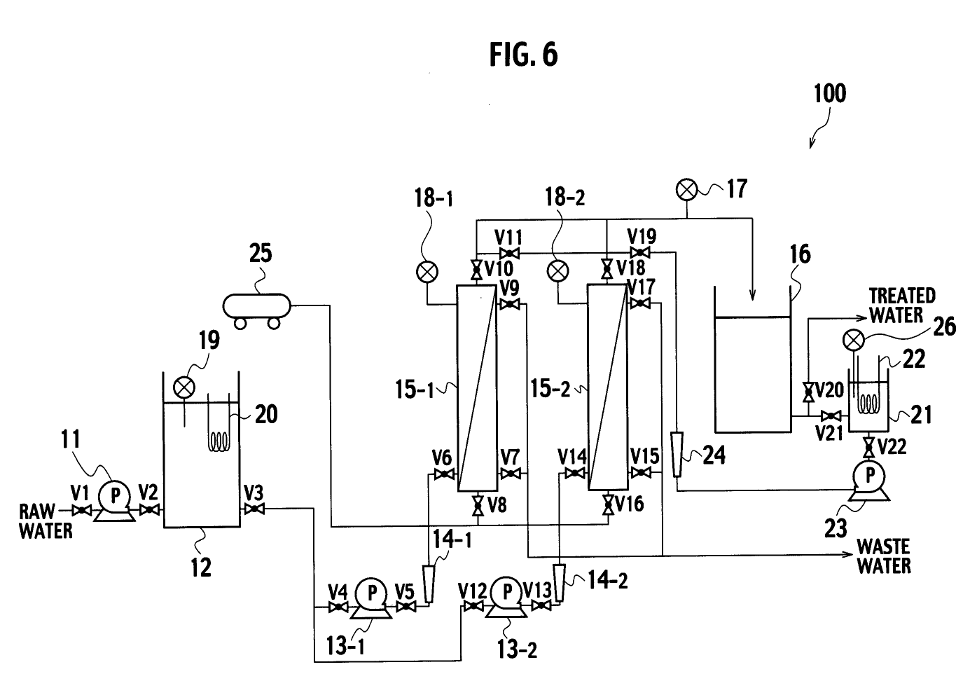

FIG. 6 is a block diagram showing a first embodiment of a membrane filtration system according to the present invention.

As an example, in the membrane filtration system 100 of this embodiment, two temperature-responsive membrane modules 15-1 and 15-2 are arranged in parallel. The membrane filtration system 100 is provided with a raw water introduction pump 11, a raw water tank 12, raw water pumps 13-1 and 13-2, flow meters 14-1 and 14-2, temperature-responsive membrane modules 15-1 and 15-2, and a treated water tank 16. The raw water tank 12 temporarily stores raw water introduced by the raw water introduction pump 11. The raw water pumps 13-1 and 13-2 supply the raw water in the raw water tank 12 respectively to the temperature-responsive membrane modules 15-1 and 15-2. The flow meters 14-1 and 14-2 respectively measure the flow amounts of the raw water introduced by the corresponding raw water pumps 13-1 and 13-2. The temperature-responsive membrane modules 15-1 and 15-2 respectively filter the raw water introduced by the corresponding raw water pumps 13-1 and 13-2 through the membranes. The treated water tank 16 stores the treated water filtered by the temperature-responsive membrane modules 15-1 and 15-2 through the membranes. In addition, the system is provided with a turbidimeter 17 and differential pressure gauges 18-1 and 18-2. The turbidimeter 17 measures the turbidity of the treated water after the membrane filtration. The differential pressure gauges 18-1 and 18-2 are provided respectively to the temperature-responsive membrane modules 15-1 and 15-2, each of which measures pressure difference between the inflow side and the discharge side in the corresponding temperature-responsive membrane module. Moreover, the system is provided with a thermometer 19 and a heater 20. The thermometer 19 measures the temperature of the raw water in the raw water tank 12 and the heater 20 heats the raw water in the raw water tank 12 at a predetermined temperature. Furthermore, the system is provided with a backwash water tank 21, a thermometer 26, a heater 22, a backwash water pump 23 and a flow meter 24. In the backwash water tank 21, part of the treated water stored in the treated water tank 16 is introduced and stored as backwash water. The thermometer 26 measures the temperature of the backwash water in the backwash water tank 21. The heater 22 heats the backwash water stored in the backwash water tank 21 at a predetermined temperature. The backwash water pump 23 supplies the backwash water in the backwash water tank 21 to the temperature-responsive membrane modules 15-1 and 15-2. The flow meter 24 measures the flow amount of the backwash water to be supplied to the temperature-responsive membrane modules 15-1 and 15-2. In addition, the system is provided with a compressor 25 which supplies pressurized air during washing. Incidentally, in FIG. 6, symbols V1 to V22 denote the valves provided respectively to pipes.

(During Filtration)

In the membrane filtration system 100 shown in FIG. 6, the raw water is introduced to the raw water tank 12 by the raw water introduction pump 11. The raw water is introduced to the temperature-responsive membrane modules 15-1 and 15-2 respectively by the raw water pumps 13-1 and 13-2. The treated water having passed through the temperature-responsive membrane modules 15-1 and 15-2 is flowed into the treated water tank 16.

(During Washing)

In the membrane filtration system 100 described above, when the raw water continuously flows therethrough, the solid contents 3 in the raw water are accumulated on the membrane surfaces, and filtration resistance thereof is thus increased. This increase results in the increase in the membrane pressure difference. For this reason, physical washing is carried out to remove reversible matters among matters adhered on the membrane surfaces or in the interior of the membrane. The physical washing is performed at a predetermined time cycle or at a time when a predetermined increase in the membrane pressure difference is found. The physical washing is performed by causing the treated water having undergone filtration to flow from the treated water side, or alternatively by supplying the compressed air from the raw water side by the compressor 25, at a predetermined time cycle or at a time when a predetermined increase in the membrane pressure difference is found.

Furthermore, on the membrane surfaces and in the interior of the membrane, the matters which cannot be removed by means of such physical washing are gradually accumulated. For this reason, when the membrane pressure difference exceeds a predetermined upper limit, the membrane filtration treatment is stopped, and chemical washing is performed thereon so as to remove the matters which have not been removed by means of the physical washing.

In the present invention, in addition to the above physical and chemical washing, a heated water washing is carried out by using heated raw water and heated treated water.

The heated water washing is performed at a predetermined time cycle or at a time when the membrane pressure difference reaches a predetermined value as in the cases of the physical and chemical washing.

The method of heating the raw water and treated water is achieved by installing the heaters 20 and 22 respectively into the raw water tank 12 and the backwash water tank 21, respectively. The raw water is heated at 25 to 60° C. by the heater 20 and supplied to the temperature-responsive membrane modules 15-1 and 15-2.

On the other hand, during the backwash of the temperature-responsive membrane modules 15-1 and 15-2, the treated water is heated at 25 to 60° C, by the heater 22 and supplied to the temperature-responsive membrane modules 15-1 and 15-2. The water used after the backwash is discharged out of the system.

At this time, the temperature of the raw water is measured by the thermometer 19, and the flow amounts of the raw water supplied to the temperature-responsive membrane modules 15-1 and 15-2 are measured by the flow meters 14-1 and 14-2 respectively. In addition, the pressure differences in the temperature-responsive membrane modules 15-1 and 15-2 are measured by the differential pressure gauges 18-1 and 18-2 respectively. The turbidity of the treated water is also measured by the turbidimeter 17.

In this embodiment, the intervals at which the physical and chemical washes are carried out are extended. For this reason, costs for the physical and chemical washing, and for the replacement of the membrane may be reduced. In addition, the treatment of the waste liquid generated when the chemical wash is carried out can also be reduced. This results in the achievement of the reduction in an environmental burden, in addition to the cost reduction.

Incidentally, in the configuration of this embodiment, the heater 22 is installed into the backwash water tank 21 such that only the amount necessary for the washing is heated. The heater 22 may be installed into the treated water tank 16 instead of the backwash water tank 21. In a case where the heater 22 is installed either in the treated water tank 16 or in the backwash water tank 21, the backwash can be carried out by the same operation as that of the physical washing hereinafter described. The frequency of the backwash is determined based on the extent of contamination of the membrane surfaces.

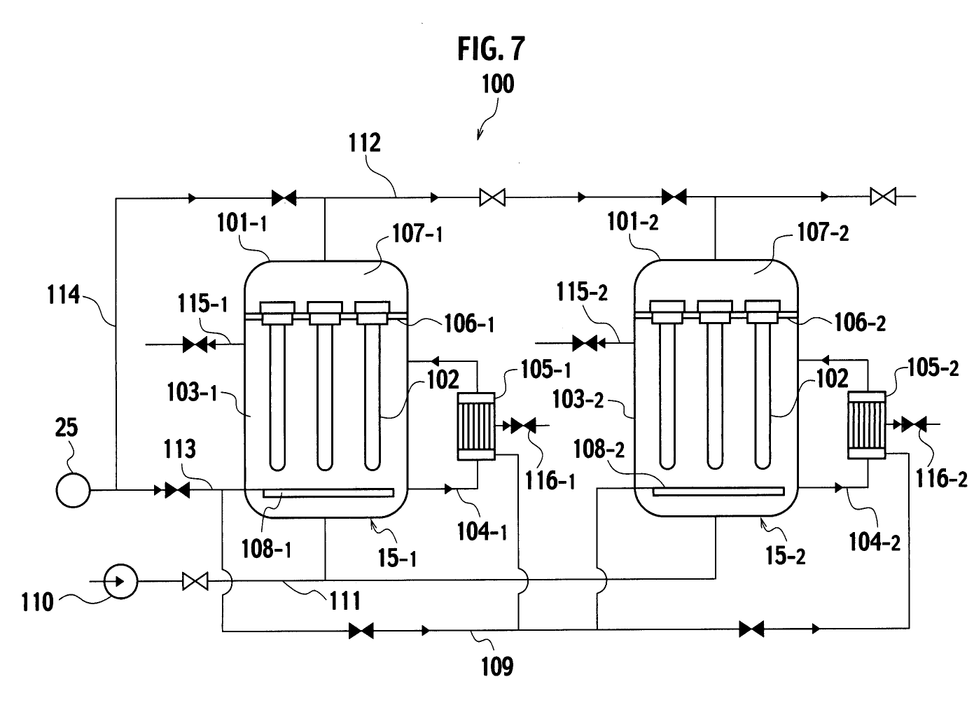

In addition, for a method of heating the raw water or treated water, for example, the following configuration may be also employed, which is provided with the temperature-responsive membrane modules 15-1 and 15-2 and heaters. Each of the temperature-responsive membrane modules 15-1 and 15-2 is formed by arranging membrane bundles of a plurality of the temperature-responsive membranes in a container. The heaters are connected respectively with raw water sides of the temperature-responsive membrane modules 15-1 and 15-2 via corresponding raw water circulation pipes. A specific configuration is shown in FIG. 7. Incidentally, the temperature-responsive membrane modules 15-1 and 15-2 are the same in configuration. In addition, operations and effects thereof are also the same. For this reason, in the following description of FIG. 7, the temperature-responsive membrane module 15-1 is mainly described.

The membrane filtration system 100 shown in FIG. 7 has a configuration in which the temperature-responsive membrane module 15-1 (15-2) is arranged in a container 101-1 (101-2). The temperature-responsive membrane module 15-1 (15-2) includes the temperature-responsive membrane bundles 102 each formed by binding a plurality of the temperature-responsive membranes together. In addition, the temperature-responsive membrane module 15-1 (15-2) is provided with a heater 105-1 (105-2) connected with a described hereinafter raw water side 103-1 (103-2) of the temperature-responsive membrane module 15-1 (15-2) via a raw water circulation pipe 104-1 (104-2).

The temperature-responsive membrane module 15-1 (15-2) shown in FIG. 7 is roughly divided into the raw water side 103-1 (103-2) and a treated water side 107-1 (107-2) by a fastening member 106-1 (106-2). The fastening member 106-1 (106-2) is formed of a potting agent. The raw water side 103-1 (103-2) contacts with the outer surface side of each membrane, and has a raw water inlet through which the raw water is supplied. The treated water side 107-1 (107-2) communicates with the inner surface side of each hollow fiber membrane via open ends thereof, and has a treated water outlet through which the treated water is taken out. Mass transfer between the raw water side 103-1 (103-2) and the treated water side 107-1 (107-2) is performed only via the membrane surfaces of the temperature-responsive membranes. Incidentally, on the raw water side 103-1 (103-2), an air release pipe 108-1 (108-2) (first air supply system) is provided in the lower part of the raw water side 103-1 (103-2).

Each of the temperature-responsive membrane bundles 102 is formed by bending a plurality of the temperature-responsive membranes in a U shape so as to bundle both ends of each of the plurality of the temperature-responsive membranes on one side (upper side in FIG. 7). The open ends of the temperature-responsive membrane bundles 102, which communicate with the inner surface side of the temperature-responsive membranes, are supported and fastened by the fastening member 106-1 (106-2). The method of fastening the temperature-responsive membranes is not particularly limited.

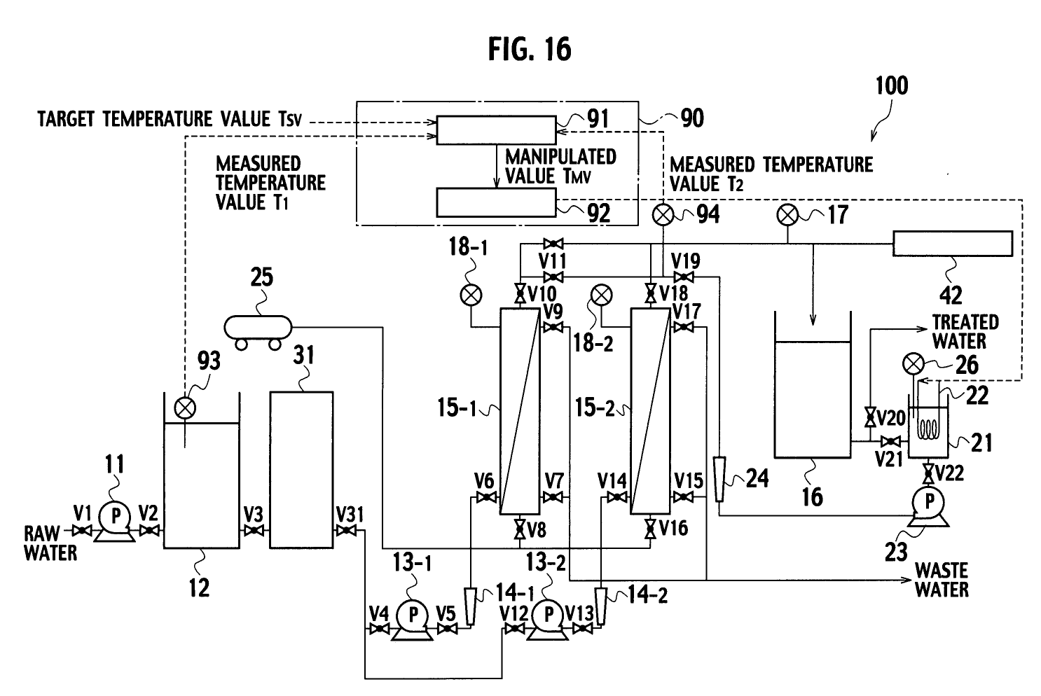

The heater 105-1 (105-2) is provided in a manner where the heater 105-1 (105-2) is connected with the raw water side 103-1 (103-2). The heater 105-1 (105-2) heats the raw water in contact with the outer surface of the membranes in the temperature-responsive membrane module 15-1 (15-2) at 25 to 60° C. Specifically, the compressed air is sent from the compressor 25 to the heater 105-1 (105-2) via a second air pipe 109 (second air supply system). Accordingly, the raw water in the temperature-responsive membrane module 15-1 (15-2), which is sent via the raw water circulation pipe 104-1 (104-2), is heated by the heater 105-1 (105-2) at 25 to 60° C. The raw water is circulated in a direction indicated by arrows in FIG. 16. As a result, the temperature of the raw water in the temperature-responsive membrane module 15-1 (15-2) is controlled to be at 25 to 60° C.

Incidentally, excessive compressed air which is supplied to the heater is discharged to an air discharge line 116-1 (116-2).

Next, a description is given below of an example of a method of using the membrane filtration system 100 in which the temperature-responsive membrane modules according to the present invention is used.

The temperature-responsive membrane module 15-1 (15-2) in which the temperature-responsive membranes are loaded is first used to filter the raw water. The raw water is supplied by using the raw water transfer pump 110 as a driving source. The raw water is transferred at a pressure by the raw water transfer pump 110 via a raw water pipe 111, and is flowed from the outer surface sides of the temperature-responsive membranes to the inner surface sides thereof. Accordingly, the solid contents in the raw water are trapped on the outer surface sides of the temperature-responsive membranes. The treated water which has been treated by the temperature-responsive membranes is transferred to a treated water pipe 112. A filtration treatment is stopped at the time when the membrane pressure difference of the temperature-responsive membranes is increased, for example, by about 50 kPa, compared with the initial value.

Note that, in the membrane filtration system 100 shown in FIG. 7, the solid contents trapped and accumulated on the membrane surfaces is washed away and removed in the following procedure. The compressed air is sent from the compressor 25 to the heater 105-1 (105-2) via the second air pipe 109. Accordingly, the raw water, which is supplied from the raw water side 103-1 (103-2) via the raw water circulation pipe 104-1 (104-2) to the heater 105-1 (105-2), is heated at 25 to 60° C. by the heater 105-1 (105-2). Subsequently, the raw water is sent to the rawwater side 103-1 (103-2). By repeating the above process the raw water is heated and circulated to control the temperature of the raw water at 25 to 60° C.

Then, the compressed air is released from the air release pipe 108-1 (108-2) via the first air pipe 113 to peel off the solid contents having adhered and accumulated on the outer surface of the temperature-responsive membranes by vibration. At the same time, the following reverse pressure washing means is carried out. The compressed air (for example, at 300 kPa) is supplied from the compressor 25 to the treated water side 107-1 (107-2) via the third air pipe 114. The treated water stagnating on the treated water side 107-1 (107-2) is flowed into the raw water side 103-1 (103-2) in a direction reverse to that of the filtration operation by using the supplied compressed air. Accordingly, back wash is carried out from the inner surface side of each temperature-responsive membrane to the outer surface thereof. At this time, the treated water on the treated water side 107-1 (107-2) is mixed in the raw water side 103-1 (103-2), so the temperature of the liquid on the raw water side is temporarily decreased below 25° C. The temperature, however, is increased at 25 to 60° C. by supplying the compressed air to the heater 105-1 (105-2) via the second air pipe 109 to heat and circulate the raw water side 103-1 (103-2). Incidentally, excessive compressed air supplied at the time of the backwash is discharged to the air discharge line 115-1 (115-2).

The supplementary description is hereinafter provided of the physical and chemical washing of the temperature-responsive membrane modules 15-1 and 15-2, which are mainly implemented in the membrane filtration system 100 for water line.

[Physical Washing of Membrane Module]

The matters having adhered to the membrane as the operation time elapses can be removed by one of or a combination of the following physical washing.

The physical washing includes reverse pressure washing, reverse air pressure washing, air scrubbing, raw water or air flush washing, mechanical vibration washing, mechanical rotary washing, ultrasonic washing, heated water washing, sponge ball washing, chemical injection washing, and ozone injection washing. The washing treatment is periodically carried out every 10 to 120 minutes corresponding to the quality of the raw water. The washing time is, not more than one minute for reverse water pressure washing, not more than several minutes for the air scrubbing, and several seconds for reverse air pressure washing.

(Chemical Washing of Membrane Module)

The matters having adhered to the membranes, which cannot be removed by means of the physical washing, can be removed by the chemical washing by one of or a combination of the following chemicals. The chemicals for the chemical washing include oxidizing agents such as sodium hypochlorite, surfactants of an alkaline cleaner, an acidic cleaner or the like, inorganic acids such as hydrochloric acid and sulfuric acid, and organic acids such as oxalic acid, and citric acid. Washing systems include an online system in which washing is carried out without separating the membrane module from the system, and an offline method in which washing is carried out while separating the membrane module from the system. The chemical washing is carried out at the time when a membrane pressure difference (100 to 200 kPa) or a filtration rate reaches the predetermined value, in a constant flow amount control system or in a constant pressure control system, respectively, at a frequency of about one to several months.

### Second Embodiment of Membrane Filtration System

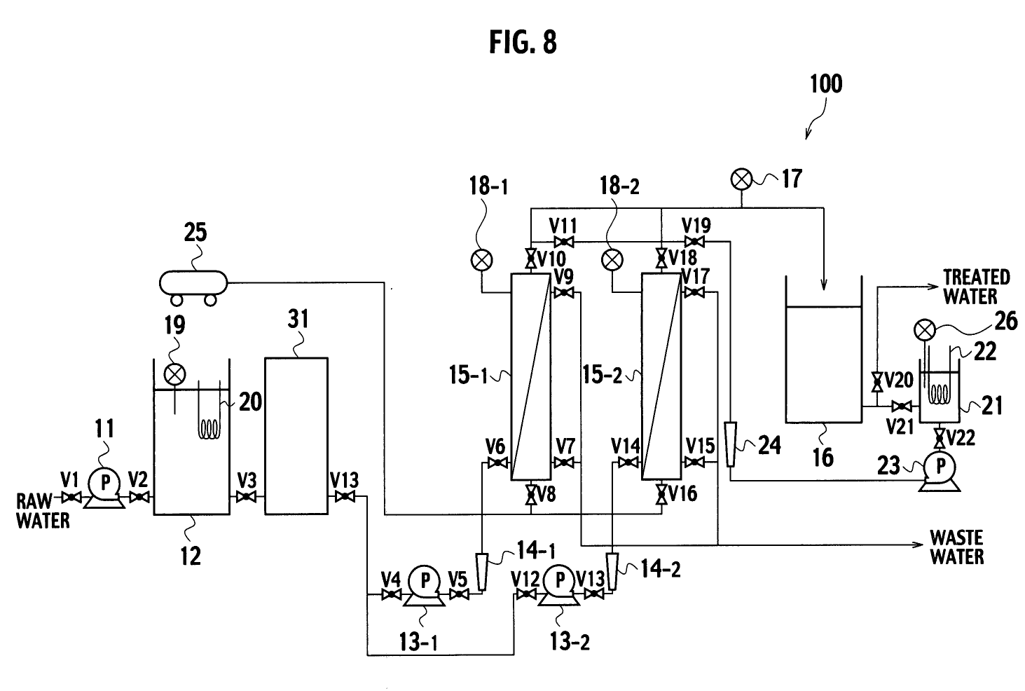

FIG. 8 shows a second embodiment of the membrane filtration system according to the present invention.

This embodiment is characterized in that pretreatment equipment is provided between the raw water tank 12 and the group of the temperature-responsive membrane modules 15-1 and 15-2. The pretreatment equipment 31 can pretreatment the raw water to be supplied to the temperature-responsive membrane modules 15-1 and 15-2 by using contaminant removing equipment, flocculant injection equipment, coagulation sedimentation equipment, coagulation and sand filtration equipment, coagulation sedimentation and sand filtration equipment, chloride injection equipment, aeration equipment, biological treatment equipment, powdered activated carbon equipment, granular activated carbon equipment, an ozone generator or a combination thereof.

Common effects of the pretreatment equipment 31 are as follows. This makes it possible to allow the temperature-responsive membrane modules 15-1 and 15-2 to exhibit their stable performance in both quantity and quality of water with the highest efficiency. This also makes it possible to prevent problems such as damage and blockage of the membrane caused by suspended matters in the raw water fed to the membrane.

### Third Embodiment of Membrane Filtration System

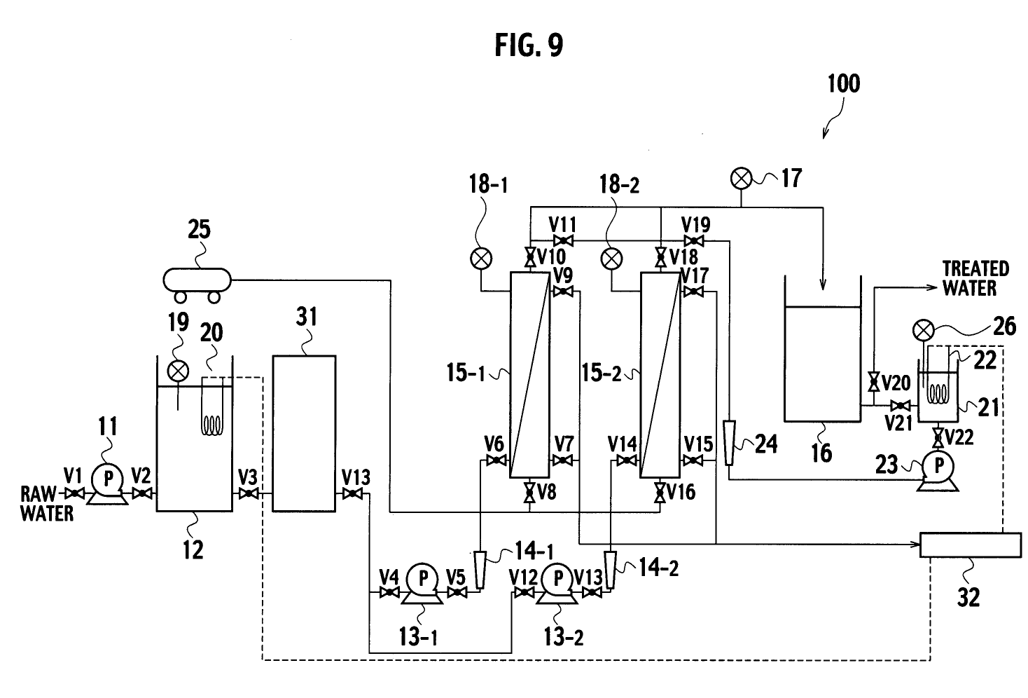

FIG. 9 shows a third embodiment of the membrane filtration system according to the present invention.

This embodiment is characterized in that waste water treatment equipment 32 is provided either in the same system as that of the membrane filtration system 100 or out of the system.

The waste water treatment equipment 32 is configured of flocculent injection equipment, coagulation sedimentation equipment, coagulation and sand filtration equipment, coagulation sedimentation and sand filtration equipment, concentration equipment, dewatering equipment, a dryer, a microfiltration membrane, a ultrafiltration membrane, a nanofiltration membrane, a reverse osmosis membrane, ultraviolet irradiation equipment, pH adjustment equipment, and an anaerobic digester, or of a combination thereof. The raw water and treated water are heated by utilizing heat discharged from, for example, the dryer, and the anaerobic digester among the above equipment.

According to the present embodiment, energy required for heating the raw water and the treated water can be reduced by effectively utilizing heat sources provided in or out of the membrane filtration system 100.

### Fourth Embodiment of Membrane Filtration System

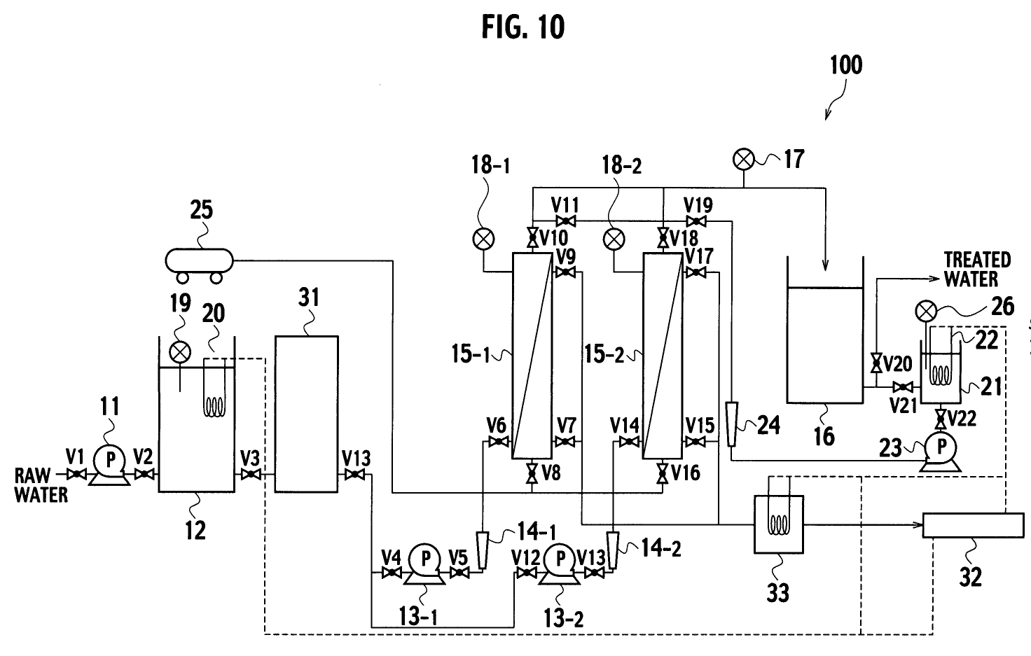

FIG. 10 shows a fourth embodiment of the membrane filtration system according to the present invention.

This embodiment is characterizes in that a heat exchanger 26 which cools wash water discharged from the membrane filtration system 100 is included.

Some local governments establish a more stringent effluent standards in their regulation based on Water Pollution Prevention Law. For example, Environmental Bureau of the Tokyo Metropolitan Government regulates that the temperature of the water discharged to public water areas shall be at not more than 40° C. In order to conform to such a standard, the heated wash water having used is cooled by a heat exchanger 26, and the recovered heat is used to heat the raw water and the treated water.

According to the present embodiment, energy required for heating the raw water and the treated water can be reduced by effectively utilizing heat sources provided in or out of the membrane filtration system 100.

### Fifth Embodiment of Membrane Filtration System

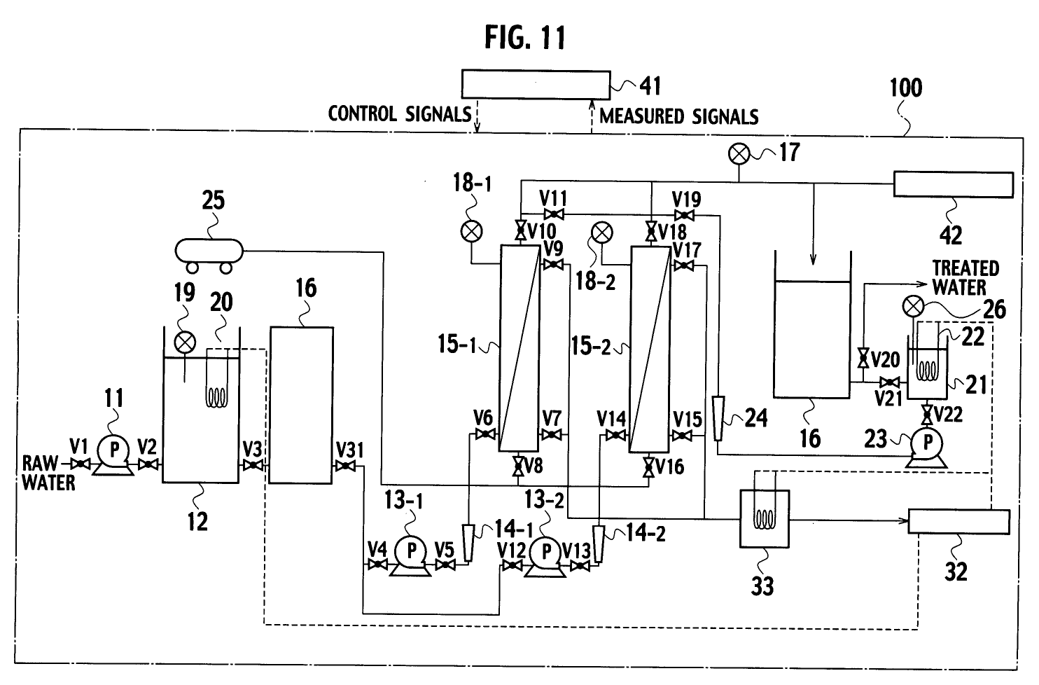

FIG. 11 shows a fifth embodiment of the membrane filtration system according to the present invention.

This embodiment is characterized in that a monitor and control device 41 and a membrane breakage detection device 42. The monitor and control device 41 continuously monitors and controls the membrane pressure difference, the flow amount of water (raw water, treated water and wash water), the temperature of water and turbidity, of the membrane filtration system 100. The membrane breakage detection device 42 confirms the completeness of the membrane. In particular, the turbidity detected by the turbidimeter 17 is an important indication for specifically monitoring protozoa such as cryptosporidium and Giardia. For this reason, it is desirable that the turbidity be full-time monitored by using a laser turbidimeter, and a transmitted light type turbidimeter.

In the membrane filtration system 100 of the present embodiment, it is necessary to monitor the membrane pressure difference and the flow amount of the water because the membrane is progressively blocked by the fine particles and suspended matters in the raw water as the operation time elapses. The monitor and control device 41 is a device for controlling equipments of the membrane filtration system 100. When measurement signals related to the membrane pressure difference, the flow amount of water (raw water, treated water and wash water), the temperature of water, or the turbidity are inputted to the monitor and control device 41, the monitor and control device 41 outputs control signals for controlling the equipments based on the inputted measurement signals. When the membrane breakage detection device 42 detects the breakage of the temperature-responsive membrane modules 15-1 and 15-2, the operations of the temperature-responsive membrane modules 15-1 and 15-2 which have been verified to be broken are temporarily stopped. It is desirable that the turbidity of the treated water is full-time monitored for detecting the breakage of the membrane by means of the laser turbidimeter or transmitted light turbidimeter. It is further desirable to monitor the turbidity once a day by diffusion air system which is a more highly sensitive detection system.

According to the present embodiment, it is possible to efficiently operate the equipments by continuously monitoring the membrane filtration system 100. Accordingly, the risk of leakage of pathogenic microorganism due to the breakage of the membrane is reduced.

### Sixth, Seventh and Eighth Embodiments of Membrane Filtration System

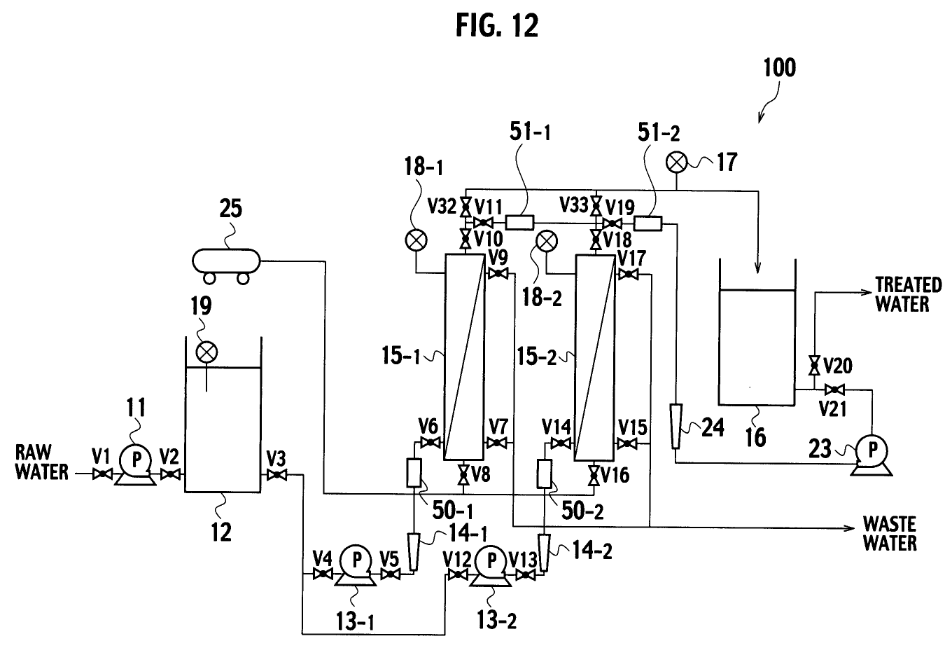

The raw water and the treated water can be heated also by using embodiments shown in FIGS. 12, 13 and 14.

In the embodiment shown in FIG. 12, heaters 50-1 and 50-2 and heaters 51-1 and 51-2 are provided. The heaters 50-1 ad 50-2 heat the raw water in the pipe immediate before the raw water is introduced into the temperature-responsive membrane modules 15-1 and 15-2. The heaters 51-1 and 51-2 heat the treated water in a pipe immediately before the treated water is introduced into the temperature-responsive membrane modules 15-1 and 15-2.

The raw water is introduced into the temperature-responsive membrane modules 15-1 and 15-2 while being heated by the heaters 50-1 and 50-2. The raw water pumps 13-1 and 13-2 are stopped when the temperature of the water in the temperature-responsive membrane modules 15-1 and 15-2 reaches 25 to 60° C. Then, the treated water heated by the heaters 51-1 and 51-2 is introduced into the temperature-responsive membrane modules 15-1 and 15-2 by the backwash water pump 23 to carry out the backwash.

Note that, either the heaters 50-1 and 50-2 on the raw water side or the heaters 51-1 and 51-2 on the treated water side may be omitted. The operations and effects of the system in a case where the heaters 50-1 and 50-2 on the raw water side are omitted are the same as those of the system shown in FIG. 6. On the other hand, in a case where the heaters 51-1 and 51-2 on the treated water side are omitted, the treated water at normal temperature is introduced into the temperature-responsive membrane modules 15-1 and 15-2 during the backwash. The temperature of the water in the temperature-responsive membrane modules 15-1 and 15-2 thus decreases to not more than 25° C. At this time, the efficiency of the backwash is reduced, however, the equipment becomes simpler, and thus, configuration becomes cost-advantageous.

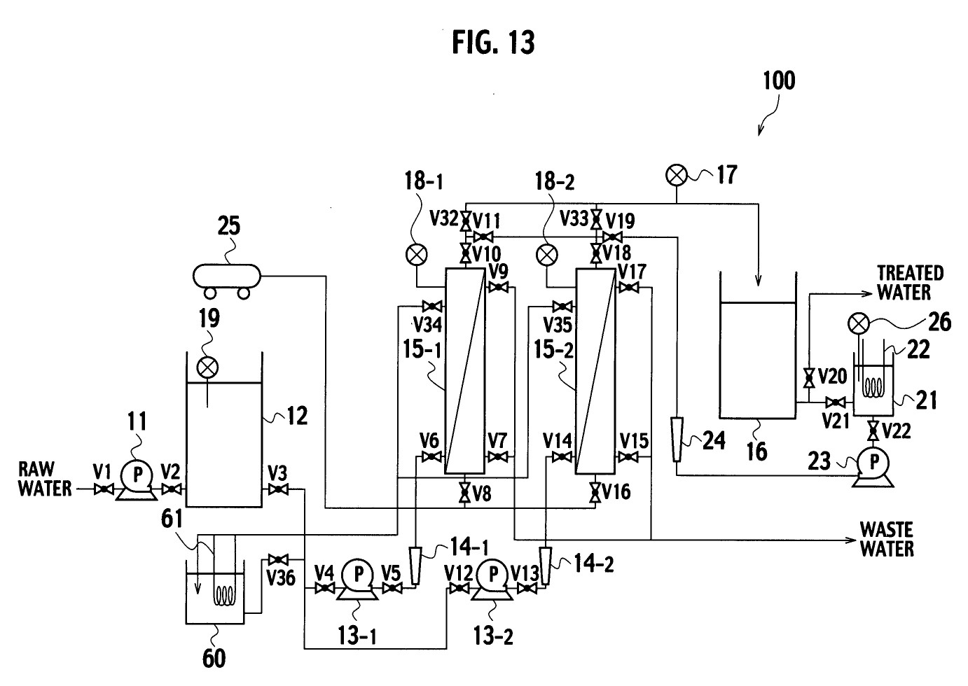

The embodiment shown in FIG. 13 is characterized in that the membrane filtration system 100 is provided with a wash water tank 60 disposed ahead of the raw water pumps 13-1 and 13-2 and a heater 61 for heating the wash water in the wash water tank 60.

When heating the raw water, the outlet valve V3 of the raw water tank 12 is closed. Heated wash water is then introduced into the temperature-responsive membrane modules 15-1 and 15-2 by the raw water pumps 13-1 and 13-2, and is circulated between the temperature-responsive membrane modules 15-1 and 15-2 and the wash water tank 60. The raw water pump 11 is stopped at the time when the temperature of the water in the temperature-responsive membrane modules 15-1 and 15-2 reaches 25 to 60° C. The Backwash is then carried out by introducing the treated water heated by the heater 22 into the temperature-responsive membrane modules 15-1 and 15-2 by the backwash water pump 23. Either the heater 61 on the raw water side or the heater 22 on the treated water side can be omitted. The operations and effects of the system in a case where the heater 61 on the raw water side is omitted are the same as those of the system shown in FIG. 6. In a case where the heater 22 on the treated water side is omitted, the treated water at normal temperature is introduced into the temperature-responsive membrane modules 15-1 and 15-2 during the backwash. Accordingly, the temperature of the water in the temperature-responsive membrane modules 15-1 and 15-2 decreases to not more than 25° C. At this time, the efficiency of the backwash is reduced, however, the equipment becomes simpler, and thus, the configuration becomes cost-advantageous.

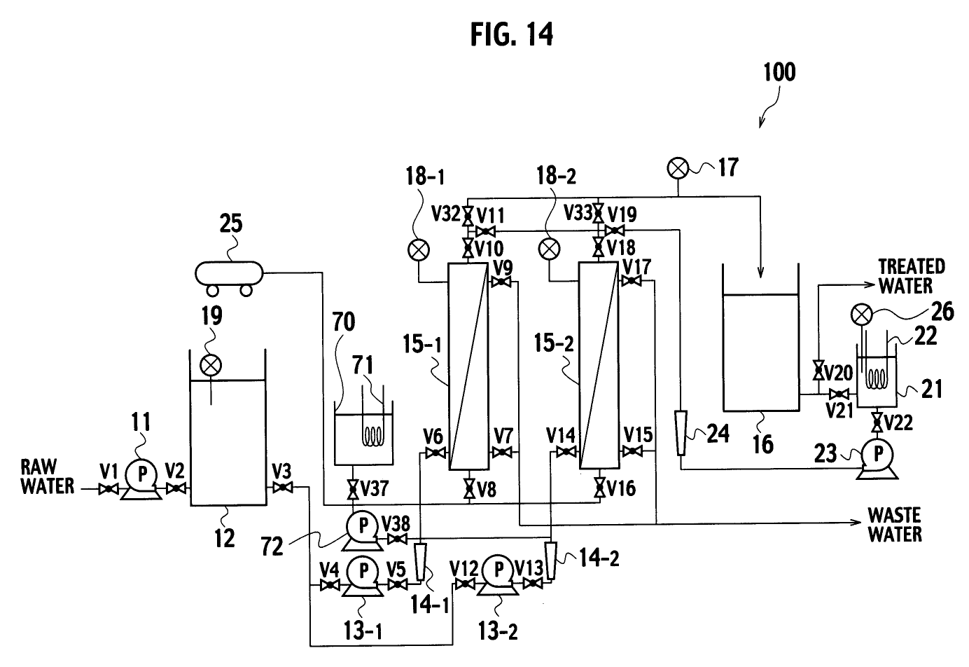

The embodiment shown in FIG. 14 is characterized in that a wash water tank 70 is provided between the raw water pumps 13-1 and 13-2 and the temperature-responsive membrane modules 15-1 and 15-2.

In this case, the raw water pumps 13-1 and 13-2 are not stopped. The interior of the temperature-responsive membrane modules 15-1 and 15-2 is heated at a temperature of 25 to 60° C. by supplying the raw water to the temperature-responsive membrane modules 15-1 and 15-2 while pushing in the wash water heated at 60 to 100° C., by a heated water pump 72. The wash water from the wash water tank 70 may be introduced at a position ahead of the raw water pumps 13-1 and 13-2. Either the heater 71 on the raw water side or the heater 22 on the treated water side can be omitted. The operations and effects of the system in a case where the heater 71 on the raw water side is omitted are the same as those of the system shown in FIG. 6. On the other hand, in a case where the heater 22 on the treated water side is omitted, the treated water at normal temperature is introduced into the temperature-responsive membrane modules 15-1 and 15-2 during the backwash. Accordingly, the temperature of the water in the temperature-responsive membrane modules 15-1 and 15-2 decreases to not more than 25° C. At this time, the efficiency of the backwash is reduced, however, the equipment becomes simpler, and thus, the configuration becomes cost-advantageous.

Incidentally, in each of the above embodiments, the system has a configuration in which two temperature-responsive membrane modules 15-1 and 15-2 are used. However, a configuration in which three or more modules are disposed in series or in parallel may be employed.

The above configuration allows a large amount of filtration to be dealt with.

### Ninth Embodiment of Membrane Filtration System

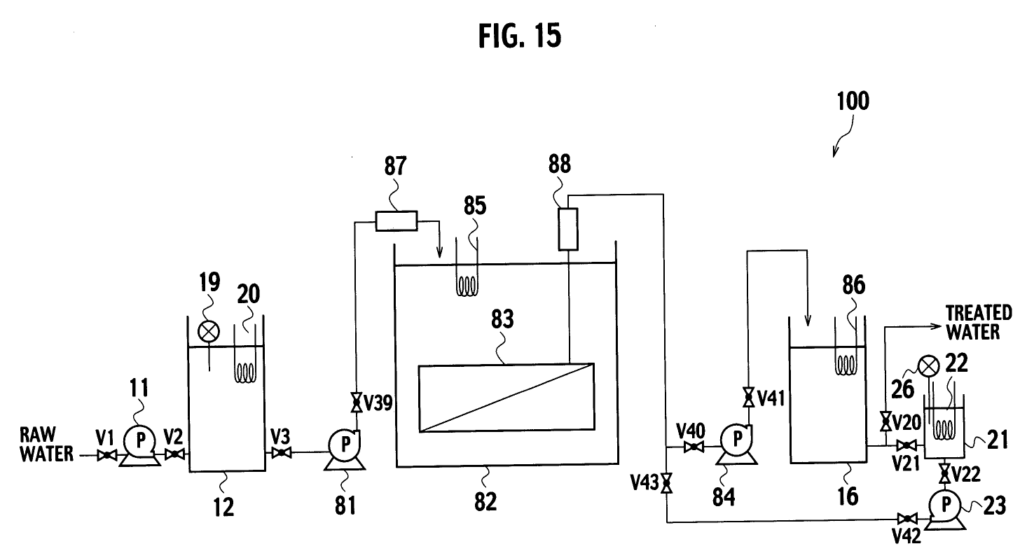

FIG. 15 shows a ninth embodiment of the membrane filtration system.

In this embodiment, shown is a configuration in which the temperature-responsive membranes are immersed in the tank (opened or closed type) into which raw water is flowed.

As shown in FIG. 15, the system is provided with a membrane immersion tank 82 for filtering the raw water introduced by a raw water pump 81 and a temperature-responsive membrane module 83 immersed in the membrane immersion tank 82. The treated water having undergone filtration is sucked into the treated water tank 16 by a suction pump 84 disposed outside the tank. In this case, the raw water is caused to permeate the temperature-responsive membranes by utilizing the membrane pressure difference generated by a water-level difference system, a suction system, or a combination thereof.

The system also includes a heater 85, heaters 20, 87 and heaters 22, 86 and 88. The heater heats the raw water in the membrane immersion tank 82. The heaters 20 and 87 heat the raw water itself to be introduced into the membrane immersion tank 82. The heaters 22, 86 and 88 heat backwash water during backwash.

Washing is carried out in the following manner. The raw water in the membrane immersion tank 82 is heated by any one of the heaters 20, 85 and 87, or by a combination thereof. Subsequently, the backwash water supplied by the backwash water pump 23 is heated at 25 to 60° C. by any one of the heaters 22, 86 and 88, or by a combination thereof. The backwash water is then supplied to the temperature-responsive membrane module 83 to carry out the washing treatment. That is, the heating on the raw water side is carried out by any of the heaters 20, 87 and 85, or by the combination thereof, and the heating on the treated water side is carried out by any of the heaters 22, 86 and 88, or by the combination thereof.

As described above, a simple system may be configured and the replacement of the membrane is facilitated since the temperature-responsive membrane module 83 consisting of the temperature-responsive membranes is immersed in the membrane immersion tank 82 into which the raw water is caused to flow. Accordingly, stable operation of the system can be achieved even in a case where the turbidity of the water to be supplied to the membranes is high.

Note that, in FIG. 15, the heating system is configured of the heaters 20, 87, and 85 on the raw water side, and the heaters 22, 86, and 88 on the treated water side, but is not limited to this. That is, on the raw water side, the heating system may be configured in a way that at least one of the heater 20 for heating the raw water in the raw water tank 12, the heater 87 for heating the raw water to be supplied from the raw water tank 12 to the membrane immersion tank 82 and the heater 85 for heating the raw water in the membrane immersion tank 82 is provided. On the treated water side, the heating system may be configured in a way that at least one of the heater 22 for heating the treated water in the backwash water tank 21, the heater 86 for heating the treated water in the treated water tank 16, and the heater 88 for heating the treated water to be supplied to the membrane immersion tank 82 is provided.

### Tenth Embodiment of Membrane Filtration System

FIG. 16 shows a configuration of the membrane filtration system provided with a heat controller.

In this embodiment, a temperature control device 90 is provided to control the temperature of the heater 22 corresponding to the temperature of the raw water.

The temperature control device 90 includes a temperature computing section 91 and a temperature controlling section 92. The temperature computing section 91 computes a target temperature value of this time from measured temperature values and a target temperature value of the last time. The temperature controlling section 92 controls the temperature of the heater 22 based on the target temperature value of this time. Moreover, the temperature control device 90 includes a thermometer 93 and a thermometer 94. The thermometer 93 measures the temperature of the raw water in the raw water tank 12 and the thermometer 94 measures the temperature of the backwash water.

In the above configuration, the temperature of the raw water in the raw water tank 12 is measured by the thermometer 93. The measured temperature value T₁ is then provided to the temperature computing section 91. On the other hand, during the backwash, the temperature of the backwash water flowing through a pipe is measured by the thermometer 94. The measured temperature value T₂ is then provided to the temperature computing section 91. The temperature computing section 91 computes a manipulated variable of this time T_{MV} from the temperature target value T_{SV}, and the measured temperature values T₁ and T₂ such that T₁ can be made smaller than T₂ at this time.

Specifically, the temperature control device 90 controls the heater 22 by means of PID control shown below to adjust the temperature of the interior of the backwash tank 21.

[Formula 1]

T₁<T₂

T_{MV}=T_{MV}(n−1)+ΔT_{MV}

ΔT_{MV}=Kp((eₙ−eₙ₋₁)+eₙΔt/Ti+Td(eₙ−2eₙ₋₁−eₙ₋₂)/Δt)

eₙ=Tₛᵥ−T₂(n)

where T_{SV}: Target temperature value

T_{MV}: Manipulated variable of this time

T_{MV}(n−1): Manipulated variable of the last time

ΔT_{MV}: Difference in manipulated variable of this time

T₂(n): Temperature of the backwash water in a control cycle of this time

eₙ: Input variation in the control cycle of this time

eₙ−1: Input variation in a control cycle of the last time

eₙ−2: Input variation in a control cycle before last

Kp: Proportional gain

Ti: Integration time

Td: Derivative time

As described above, in this embodiment, the backwash can be carried out under a precise temperature control by performing the temperature control of the heater 22 by the temperature control device 90.

What is claimed is:

1. A temperature-responsive membrane comprising:
a membrane substrate formed of a polymeric material and having pores therein; and
pore diameter adjustment members each formed by adding a polymeric material on the outer surface of the membrane substrate, the polymeric material reversibly expanding/contracting at a predetermined temperature, wherein
the pores formed in the membrane substrate have the maximum pore diameter of 100 μm or less at 25 to 60° C., and
the polymeric material composed of at least one material selected from the group consisting of:
(1) polymers formed by copolymerizing N-isopropyl acrylamide with acrylic acid, 2-carboxy isopropyl acrylamide and 3-carboxy-n-propyl acrylamide;
(2) N-vinyl isobutyric acid amide copolymers;
(3) poly-N-alkyl acrylamide derivatives;
(4) copolymers of polyacrylamide derivatives represented by polyisopropyl acrylamide with polyvinyl derivatives;
(5) copolymers of N-vinylC₃₋₉acylamide including N-vinyl isobutyric acid amide with N-vinylC₁₋₃acylamide including N-vinyl acetamide;
(6) polyacrylamide derivatives and poly-N-vinyl acylamide; and
(7) polymers of monomers consisting of N-isopropyl acrylamide and polymers of monomers consisting of N-vinyl isobutyric acid amide.

2. A temperature-responsive membrane module, wherein
the temperature-responsive membrane as recited in claim 1 is formed into any one of planar and cylindrical forms, and is filled into a container.

3. A temperature-responsive membrane module, wherein
a plurality of the temperature-responsive membranes as recited in claim 1 are formed into any one of planar and cylindrical forms, and are immersed in a tank into which raw water is flowed.

4. A membrane filtration system comprising
a temperature-responsive membrane module for filtering supplied raw water to discharge it as treated water, in which the temperature-responsive membrane as recited in claim 1 is formed into any one of planar and cylindrical forms, and is filled into a container.

5. A membrane filtration system comprising
a temperature-responsive membrane module for filtering supplied raw water to discharge it as treated water, in which a plurality of the temperature-responsive membranes as recited in claim 1 are formed into any one of planar and cylindrical forms, and are immersed in a tank into which raw water is flowed.

6. The membrane filtration system as recited in claim 4 comprising
a plurality of the temperature-responsive membrane modules disposed in series or in parallel.

7. The membrane filtration system as recited in claim 5 comprising
a plurality of the temperature-responsive membrane modules disposed in series or in parallel.

8. The membrane filtration system as recited in any one of claims 4 to 7 comprising
a washing means for performing washing treatment by supplying all or part of any one of the raw water and the treated water to the temperature-responsive membrane module.

9. A membrane filtration system as recited in claim 8, wherein
the washing means performs the washing treatment by means of at least one or a combination of physical washing, chemical washing and heated water washing.

10. The membrane filtration system as recited in claim 8, wherein
the washing means has a raw-water heating means for heating the raw water at 25 to 60° C., and performs heated water washing by using the heated raw water during washing the membranes.

11. The membrane filtration system as recited in claim 10, wherein
the raw-water heating means utilizes a heat source of a waste water treatment equipment to perform the heated water washing, the waste water treatment equipment being disposed in or out of the system.

12. The membrane filtration system as recited in claim 10, wherein
the washing means has a treated-water heating means for heating the treated water at 25 to 60° C., and performs the heated water washing by using the heated raw water and treated water during washing the membranes.

13. The membrane filtration system as recited in claim 12, wherein
the treated-water heating means utilizes a heat source of a waste water treatment equipment to perform the heated water washing, the waste water treatment equipment being disposed in or out of the system.

14. The membrane filtration system as recited in any one of claims 10 to 13 comprising
a heat exchanger for cooling a heated discharged water discharged from the temperature-responsive membrane modules.

15. The membrane filtration system as recited in claim 12 comprising
a raw-water temperature measurement means for measuring a temperature of the raw water;
a backwash water temperature measurement means for measuring a temperature of a backwash water;
a temperature computing means for computing a target value of temperature of the backwash water by receiving the measured values of the temperatures of the raw water and the backwash water in order that the temperature of the backwash water can be cause to become higher than the temperature of the raw water; and
a temperature control means for performing heating control on the treated-water heating means based on the computed target temperature value.

16. The membrane filtration system as recited in any one of claims 4 to 7 comprising
pretreatment equipment ahead of the temperature-responsive membrane modules.

17. The membrane filtration system as recited in claim 16, wherein
the pretreatment equipment performs a pretreatment on the raw water by using any one or a combination of contaminant removing equipment, flocculant injection equipment, coagulation sedimentation equipment, coagulation and sand filtration equipment, coagulation sedimentation and sand filtration equipment, chloride infusion equipment, aeration equipment, floatation separation equipment, biological treatment equipment, powdered activated carbon equipment, ozone generator, granular activated carbon equipment.

18. The membrane filtration system as recited in any one of claims 4 to 7 comprising
a pressure gauge, a flow meter, a water temperature meter, and a turbidimeter, for continuously monitoring and controlling a membrane pressure difference, an amount of water flow, a water temperature, and a turbidity, respectively, and a membrane breakage detection means for confirming completeness of the membrane.
